(19) United States
(12) Patent Application Publication
(10) Pub. No.: US 2002/0053581 A1
(43) Pub. Date: May 9, 2002

(54) Vehicle roof mounted bicycle carrier

(76) Inventors: Joseph J. Peschmann, Plover, WI (US); Christopher M. Morris, Schofield, WI (US); Todd A. Trowbridge, Wausau, WI (US); Gregg Bednorski, Wausau, WI (US)

Correspondence Address: Edgar A. Zarins, MascoTech, Inc., 21001 Van Born Rd., Taylor, MI, 48180, US

(21) Appl. No.: 09/770,737

(22) Filed: Jan. 26, 2001

Related U.S. Application Data
(60) Provisional application No. 60/246,881, filed on Nov. 8, 2000.

(51) Int. Cl. B60R 9/10; B60R 9/048

(52) U.S. Cl. 224/319; 224/324; 224/924

(57) ABSTRACT

A bicycle carrier which is detachably mounted to a roof rack of a motor vehicle. The carrier includes clamping assemblies which receive the cross members of the roof rack. The clamps include manipulable nuts for adjusting the clamping force with the cross members. The clamp assemblies are attached to cross bars which support wheel trays that nestingly receive the rear wheel of the bicycle and provide stability to the bike. A fork clamp is positioned at one end of the tray for lockingly receiving the front fork of the bicycle. The front wheel is stored in a rack mounted to the carrier frame.

### RELATED APPLICATIONS

This application claims priority from U.S. Provisional Application No. 60/248,881 filed on Nov. 8, 2000.

### BACKGROUND OF THE INVENTION

I. Field of the Invention

This invention relates to a bicycle carrier selectively mountable to a roof rack of a motor vehicle and, in particular, to a carrier which lockingly secures the bicycle using the front fork of the bike and includes means for retaining the removed front wheel of the bicycle.

II. Description of the Prior Art

With the increased popularity of outdoor recreational pursuits, vehicle manufacturers and recreational outfitters are continually developing convenient means for transporting the outdoor enthusiast's equipment. Such devices can include hitch mounted racks and storage platforms or carriers which mount to the roof of the vehicle. These exteriorly mounted racks facilitate the transport of the recreational equipment without taking up interior cargo and passenger space. The roof and hitch mounted carriers also place the equipment in a convenient, easily unloaded position.

The hitch mounted carriers have limited usefulness because not all vehicles have a hitch receiver which is typically an after market addition to a vehicle. However, roof carriers can be secured to most any vehicle. The carrier may include straps or clamps for securing the rack to the edges or molding of the vehicle top. Such devices tend to be cumbersome to mount and therefore may be left on the roof despite their unsightliness. Carriers that are mounted directly to the roof can also scratch or mar the surface finish.

### SUMMARY OF THE PRESENT INVENTION

The present invention overcomes the disadvantages of the prior known bicycle carriers by providing a complete carrier which can be conveniently detachably clamped to a roof rack of a vehicle for securely transporting one or more bicycles.

The bicycle carrier of the present invention incorporates a substantially rectangular frame structure adapted to be detachably mounted to a fixed roof rack of a vehicle. The carrier frame includes lateral cross bars and longitudinal trays for receiving the bicycles. Manual clamps for securing the carrier to the roof rack are disposed at the corners of the carrier frame. The relative positions of the cross bars and trays are adjustable such that the clamps will be positioned to engage the roof rack, specifically the cross members of the rack. The clamp assemblies are used to capture the cross members to detachably secure the carrier to the roof rack.

The longitudinal trays are configured to receive at least the rear wheel of a bicycle. Disposed at a forward end of the tray is a releasable clamp designed to lockingly receive the front fork of the bicycle. Similar to the wheel locks found on bicycles to allow the quick removal of the front wheel, these clamps include an axle upon which the fork rests and a wedge clamp to retain the fork. The removed front wheel can be stored in an upright fork associated with the rear cross bar.

The bicycle carrier universally fits all original manufacturer roof racks by providing an adjustable structure and can be readily mounted and removed as a complete structure to facilitate repeated use. In a preferred embodiment, the longitudinal tray includes a slot on the underside thereof which receive the fasteners of the clamps. As a result, the spacing of the cross bars and clamps can be adjusted to fit the spacing of the roof rack cross members. Since the rear wheel seats in a longitudinal tray, bicycles of different sizes can be accommodated while the fork holders retain the bike. The ease of use and compatibility creates an improved bicycle carrier for a motor vehicle.

Other objects, features and advantages of the invention will be apparent from the following description taken in connection with the accompanying drawings.

### BRIEF DESCRIPTION OF THE DRAWING

The present invention will be more fully understood by reference to the following detailed description of a preferred embodiment of the present invention when read in conjunction with the accompanying drawing, in which like reference characters refer to like parts throughout the views and in which:

FIG. 1 is a perspective view of a motor vehicle having the bicycle carrier embodying the present invention and having a bicycle mounted thereto;

FIG. 2 is a perspective view of the bicycle carrier;

FIG. 3 is an enlarged view of a front clamping assembly; and

FIG. 4 is an enlarged view of a rear clamping assembly.

### DETAILED DESCRIPTION OF A PREFERRED EMBODIMENT OF THE PRESENT INVENTION

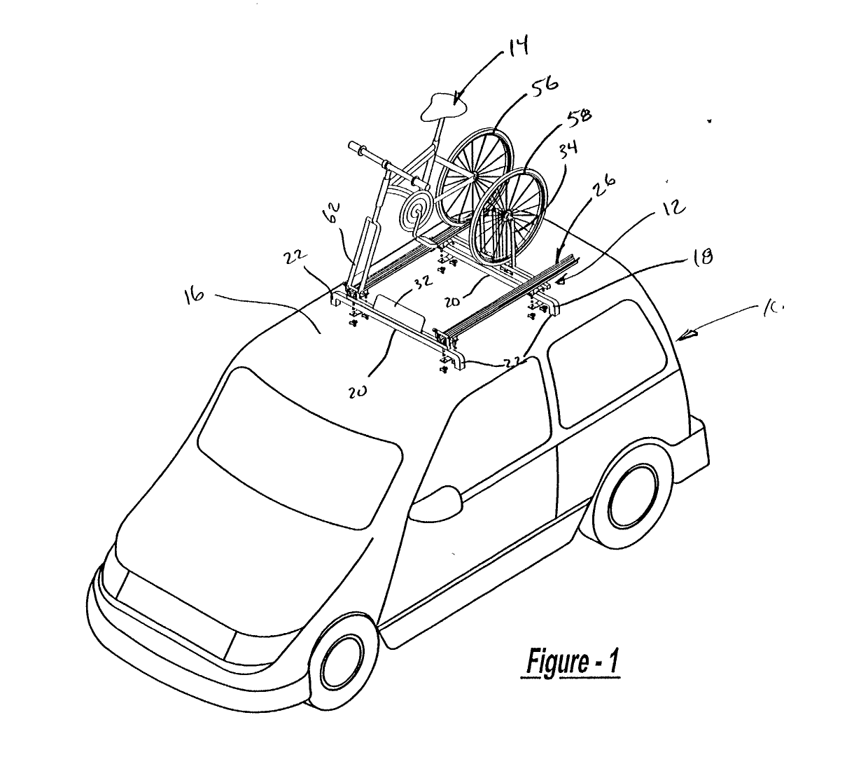

Referring first to FIG. 1, there is shown a motor vehicle 10 for transporting passengers and cargo and including a carrier 12 for transporting a plurality of bicycles 14. The vehicle 10 includes a roof 16 or similar flat surface with a luggage rack 18 fixedly mounted to the roof 16. The luggage or roof rack 18 is installed on the vehicle 10 by the manufacturer or vehicle dealer although such racks 18 are available as aftermarket products. The luggage racks 18 typically include front and back cross members 20 which extend laterally across the vehicle 10 and are spaced above the vehicle surface 16 by end stanchions 22. The cross members 20 operate as barriers for cargo that may be placed therebetween on the plurality of longitudinal slats 24. The bicycle carrier 12 is detachably mounted to the cross members 20 of the roof rack 18 in order to transport bicycles 14 above the vehicle 10.

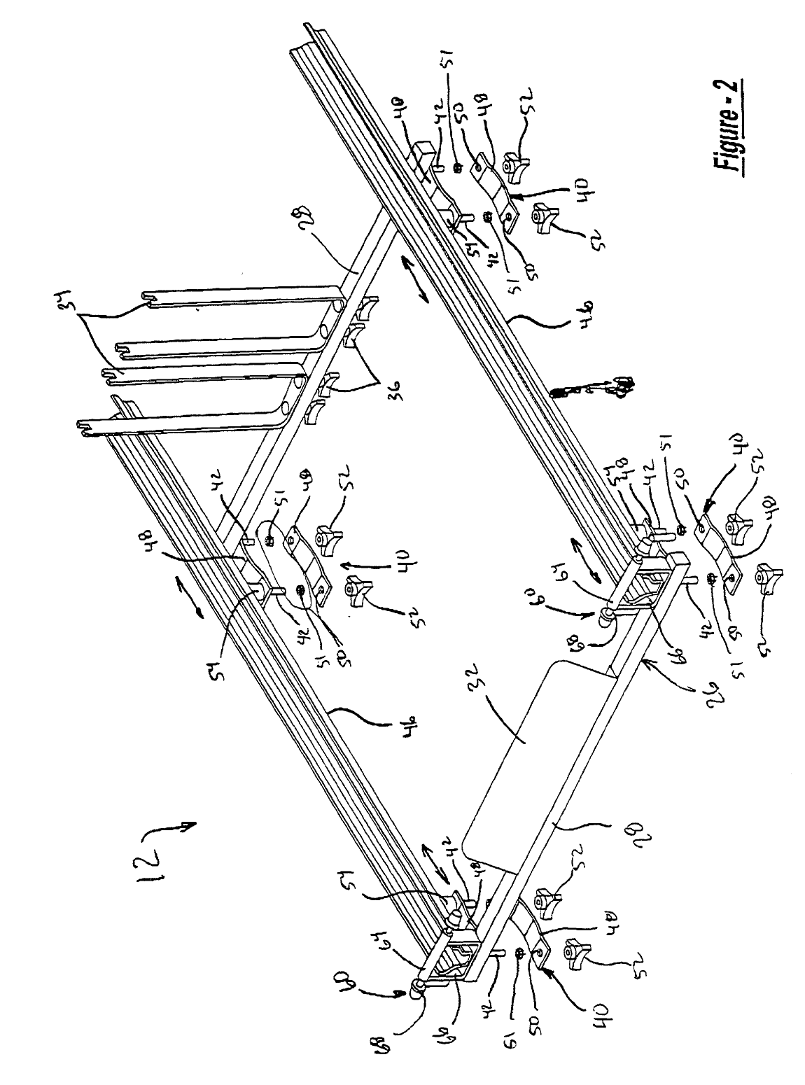

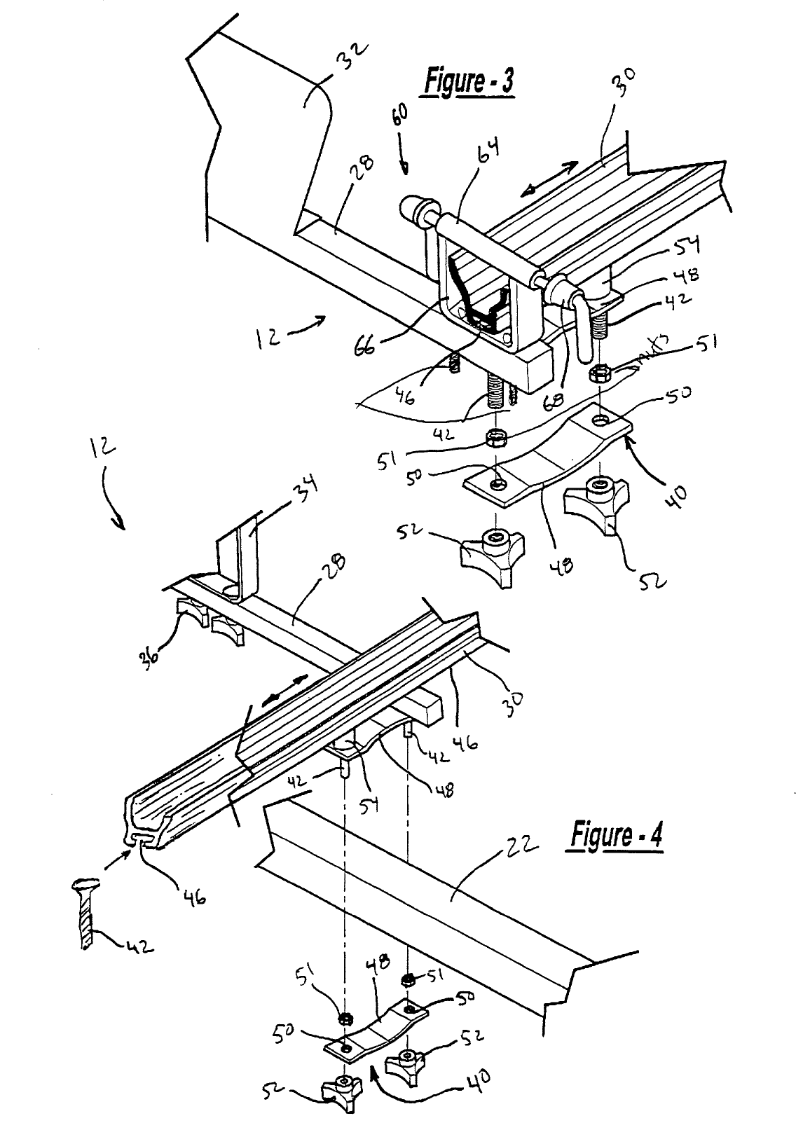

Referring now to FIGS. 2 through 4, the bike carrier 12 has a substantially rectangular frame 26 which can be adjusted to facilitate mounting to the cross members 20 of the roof rack 18 as will be subsequently described. The frame 26 includes a pair of cross bars 28 designed to extend laterally across the vehicle 10 and a plurality of longitudinal trays 30 for receiving a bicycle 14. The longitudinal trays 30 are adjustably connected to the cross bars 28 such that the spacing between the cross bars 28 can be adjusted to accommodate the roof rack 18. The cross bars 28 may be provided with additional components to improve operation. A wind deflector 32 may be secured to the front cross bar 28 to improve aerodynamics. The rear cross bar 28 may include a plurality of detachable forks 34 adapted to receive a wheel of the bicycle 14 as will be described. The forks 34 are preferably secured to the cross bar 28 by manual knob nuts 36 to facilitate convenient removal.

The carrier 12 is secured to the roof rack 18 by a plurality of clamps 40 which also adjustably mount the trays 30 to the cross bars 28. Each of the clamps 40 includes at least one, but preferably a pair of, bolts 42 having a head 44 which is movably received within an underside slot 46 extending longitudinally of the trays 30. The movement of the bolts 42 along the underside slot 46 facilitates adjustment of the frame 26. The clamps 40 have a pair of clamp bars 48 having apertures 50 through which the bolts 42 extend. First nuts 51 are used to maintain the upper clamp bar 48 on the fasteners 42 so that the assembled rack 12 can be lifted onto the roof rack 18 and clampingly attached using the bottom clamp bar 48. Secondary hand nuts 52 threadably mounted to the bolts 42 are used to tighten the clamp bars 48 against the roof rack components. In a preferred assembly of the carrier 12, one of the bolts 42 of each of the clamps 40 extends through a corresponding cross bar 28 to fix the clamps 40 relative to the cross bars 28. However, because the bolt heads 44 can slide within the longitudinal slot 46, the position of the tray 30 relative to the cross bars 28 and clamps 40 can be adjusted. In order to accommodate the cross bars 28, each of the clamps 40 includes a spacer 54 to maintain the clamp bars 48 in the proper orientation.

In order to secure the individual bicycles 14 to the carrier 12, each of the trays 30 is provided with a fork lock 60. The trays 30 are configured to receive a wheel of the bicycle 14, preferably the rear wheel 56 to stabilize the bike 14. The front wheel 58 is stored in the auxiliary forks 34 or within the vehicle 10. The fork lock 60 is adapted to receive the front fork 62 of the bicycle 14 upon removal of the front wheel 58. The fork lock 60 includes an axle 64 mounted to a support member 66 which is fastened to the cross bar 28, preferably the front cross bar 28. The slots of the bicycle fork 62 engage the axle 64, which includes a locking mechanism 68 to lockingly retain the fork 62 during transport of the bicycle. In a preferred embodiment, the locking mechanism 68 is a quick release mechanism similar to the quick release locks used to secure the wheels 56, 58 to the bicycle 14. With the rear wheel 56 supported in the tray 30, the quick release locking mechanism 68 accommodates removal of the bicycle 14 from the carrier 12.

Use of the bicycle carrier 12 of the present invention invites simple mounting of the carrier 12 to the vehicle 10 and mounting of one or more bicycles 14 onto the carrier 12. The frame 26 of the carrier 12 is adjusted by moving the cross bars 28 to a spacing which substantially corresponds to the spacing of the cross members 22 of the roof rack 18. Upon proper adjustment, the clamps 40 will accommodate the cross members 22. With the cross member 22 secured within the clamps 40, the bicycles 14 may be loaded onto the carrier 12. The front wheel 58 is removed and the front fork 62 is positioned on the fork lock 60 as the rear wheel 56 is seated in the longitudinal tray 30. The locking mechanism 68 of the fork lock 60 is engaged to secure the bicycle 14. A hold down strap (not shown) may be utilized to prevent the rear wheel 56 from jumping out of the tray 30.

The foregoing detailed description has been given for clearness of understanding only and no unnecessary limitations should be understood therefrom as some modifications will be obvious to those skilled in the art without departing form the scope and spirit of the appended claims.

What is claimed is:

1. A bicycle carrier adapted to be secured to a cargo rack of a vehicle for transport of a bicycle, said bicycle carrier comprising:
an adjustable frame;
clamping means attached to said frame for detachably securing said frame to the vehicle cargo rack, said clamping means adapted to lockingly engage the cargo rack; and
a locking mechanism mounted to said frame and adapted to lockingly retain the bicycle.

2. The bicycle carrier as defined in claim 1 wherein said adjustable frame includes a pair of lateral cross bars and at least one longitudinal tray for receiving the bicycle, said cross bars selectively adjustable relative to said at least one longitudinal tray to adjust the dimensions of said frame.

3. The bicycle carrier as defined in claim 2 wherein said adjustable frame includes a pair of longitudinal trays, each of said trays adapted to receive the bicycle.

4. The bicycle carrier as defined in claim 3 wherein said locking mechanism is a fork lock mounted to said frame proximate said longitudinal tray, said fork lock lockingly receiving a portion of the bicycle to maintain the bicycle in said longitudinal tray of said carrier.

5. The bicycle carrier as defined in claim 3 wherein said clamping means attached to said frame includes a plurality of clamps movably mounted to said longitudinal trays, said clamps adapted to clampingly receive the cargo rack.

6. The bicycle carrier as defined in claim 5 wherein said longitudinal trays include a longitudinal slot open to an underside of said trays, said longitudinal slot receiving said clamps for movement of said clamps along said slot.

7. The bicycle carrier as defined in claim 6 wherein said clamps include a bolt, said bolt slidably received within said slot of said longitudinal tray.

8. The bicycle carrier as defined in claim 6 wherein said clamps are fixedly secured to said cross bars such that said clamps and cross bars are selectively adjustable relative to said longitudinal tray.

9. The bicycle carrier as defined in claim 2 and further comprising means for storing a wheel of the bicycle separated from the bicycle.

10. A bicycle carrier adapted to be secured to a cargo rack of a vehicle for transport of a bicycle, said bicycle carrier comprising:
an adjustable frame having a pair of lateral cross bars and a pair of longitudinal trays adapted to receive a bicycle, said cross bars selectively adjustable relative to said longitudinal trays to adjust a dimension of said frame;
clamps mounted to said frame for detachably securing said frame to the vehicle cargo rack, said clamps adapted to lockingly engage the cargo rack; and
a locking mechanism mounted to said frame proximate said longitudinal trays and adapted to lockingly retain the bicycle.

11. The bicycle carrier as defined in claim 10 wherein said locking mechanism is a fork lock adapted to lockingly receive a portion of the bicycle to maintain the bicycle within said longitudinal tray of said carrier.

12. The bicycle carrier as defined in claim 10 wherein said clamps are movably mounted to said longitudinal trays for spatial adjustment to accommodate the cargo rack.

13. The bicycle carrier as defined in claim 12 wherein said longitudinal trays include a longitudinal slot open to an underside of said trays, said longitudinal slot receiving said clamps for movement of said clamps along said slot.

14. The bicycle carrier as defined in claim 13 wherein said clamps are fixedly secured to said cross bars such that said clamps and cross bars are selectively adjustable relative to said longitudinal tray.
